(19) United States
(12) Patent Application Publication
(10) Pub. No.: US 2026/0353489 A1
(43) Pub. Date: Nov. 5, 2026

(54) DEVICE INTERACTION METHOD AND ELECTRONIC DEVICE

(71) Applicant: Lenovo (Beijing) Limited, Beijing (CN)

(72) Inventors: Shuai LIN, Beijing (CN); Yong YU, Beijing (CN)

(21) Appl. No.: 19/720,886

(22) Filed: Jun. 26, 2026

Related U.S. Application Data
(63) Continuation of application No. PCT/CN2024/117366, filed on Sep. 6, 2024.

(30) Foreign Application Priority Data
Dec. 29, 2023 (CN) 202311865010.7

(51) Int. Cl. H04W 76/15

(52) U.S. Cl. CPC H04W 76/15

(57) ABSTRACT

A device interaction method includes: obtaining, in response to a first device being in an external device scanning stage, a first network protocol probe frame sent by a third device, the first network protocol probe frame carrying second information of at least one second device; parsing the first network protocol probe frame, and obtaining second connection information included in the second information and used for establishing a connection with an external device; and determining that the first device requests to connect to a second device of the at least one second device, and establishing a connection with the second device based on the second connection information.

### CROSS-REFERENCE TO RELATED APPLICATION

This application is a continuation of International Application No. PCT/CN 2024/117366, filed on Sep. 6, 2024, which claims priority to Chinese Patent Application No. 202311865010.7, filed on Dec. 29, 2023, the entire contents of both of which are incorporated herein by reference.

### TECHNICAL FIELD

The present disclosure relates to the field of wireless communications, and relates to, but is not limited to, a device interaction method and an electronic device.

### BACKGROUND

In existing technical solutions, when devices need to be connected, a process of discovering and searching for devices and exchanging information is performed before each connection. For example, information is exchanged through Bluetooth before devices are connected. Accordingly, before making the connection, device information needs to be exchanged to perform negotiations between the devices, which increases the time consumed for device connection. How to improve the efficiency of connection between devices has become a technical problem that urgently needs to be solved.

### SUMMARY

In accordance with the present disclosure, there is provided a device interaction method including: obtaining, in response to a first device being in an external device scanning stage, a first network protocol probe frame sent by a third device, the first network protocol probe frame carrying second information of at least one second device; parsing the first network protocol probe frame, and obtaining second connection information included in the second information and used for establishing a connection with an external device; and determining that the first device requests to connect to a second device of the at least one second device, and establishing a connection with the second device based on the second connection information.

Also in accordance with the present disclosure, there is provided an electronic device including a processor, and a memory storing an application program that, when executed by the processor, causes the electronic device to obtain, in response to a first device being in an external device scanning stage, a first network protocol probe frame sent by a third device, the first network protocol probe frame carrying second information of at least one second device, parse the first network protocol probe frame, and obtain second connection information included in the second information and used for establishing a connection with an external device, and determine that the first device requests to connect to a second device of the at least one second device, and establish a connection with the second device based on the second connection information.

Also in accordance with the present disclosure, there is provided a non-transitory computer-readable storage medium storing an application program that, when executed by a processor, causes an electronic device including the processor to: obtain, in response to a first device being in an external device scanning stage, a first network protocol probe frame sent by a third device, the first network protocol probe frame carrying second information of at least one second device, parse the first network protocol probe frame, and obtaining second connection information included in the second information and used for establishing a connection with an external device, and determine that the first device requests to connect to a second device of the at least one second device, and establish a connection with the second device based on the second connection information.

### BRIEF DESCRIPTION OF THE DRAWINGS

FIG. 1A is a schematic flowchart of a device interaction method consistent with the present disclosure.

FIG. 1B schematically shows an MAC frame structure consistent with the present disclosure.

FIG. 1C schematically shows a Frame Control structure consistent with the present disclosure.

FIG. 1D is a table of a Type byte and a Subtype byte consistent with the present disclosure.

FIG. 1E schematically shows an Element structure consistent with the present disclosure.

FIG. 1F is an Element ID filling table consistent with the present disclosure.

FIG. 1G schematically shows a Vendor Specific 221 frame structure consistent with the present disclosure.

FIG. 1H schematically shows the filling content of a Vendor Specific 221 frame consistent with the present disclosure.

FIG. 2 is a schematic flowchart of a method for a first device to send a probe request frame consistent with the present disclosure.

FIG. 3A is a schematic structural diagram of a first device consistent with the present disclosure.

FIG. 3B is a schematic structural diagram of a third device consistent with the present disclosure.

FIG. 4 is a schematic structural diagram of a device interaction system consistent with the present disclosure.

FIG. 5 is a schematic structural diagram of a device interaction apparatus consistent with the present disclosure.

FIG. 6 is a schematic diagram of a hardware entity of an electronic device consistent with the present disclosure.

### DETAILED DESCRIPTION OF THE EMBODIMENTS

To make the objectives, technical solutions, and advantages of embodiments of the present disclosure clearer, the specific technical solutions of embodiments of the present disclosure will be described in further detail below with reference to the accompanying drawings. The following embodiments are used to illustrate the present disclosure, but are not intended to limit the scope of the present disclosure.

In the following description, reference to “some embodiments” describes a subset of all possible embodiments. However, it can be understood that “some embodiments” may be the same subset or different subsets of all possible embodiments, and may be combined with one another where no conflict exists.

In the following description, the terms associated with “first”, “second”, and “third” are merely used to distinguish similar objects and do not represent a specific ordering of the objects. It can be understood that “first”, “second”, and “third” may be interchanged in terms of a specific order or sequence where permitted, such that embodiments of the present disclosure described herein may be implemented in an order other than the order illustrated or described herein.

Unless otherwise defined, all technical and scientific terms used herein have the same meanings as commonly understood by a person skilled in the technical field of the present disclosure. The terms used herein are only for the purpose of describing embodiments of the present disclosure and are not intended to limit the present disclosure.

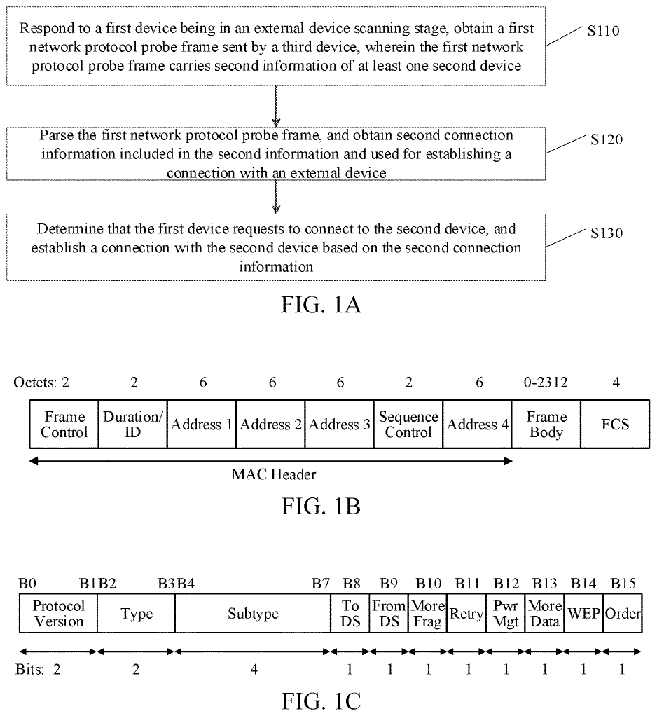

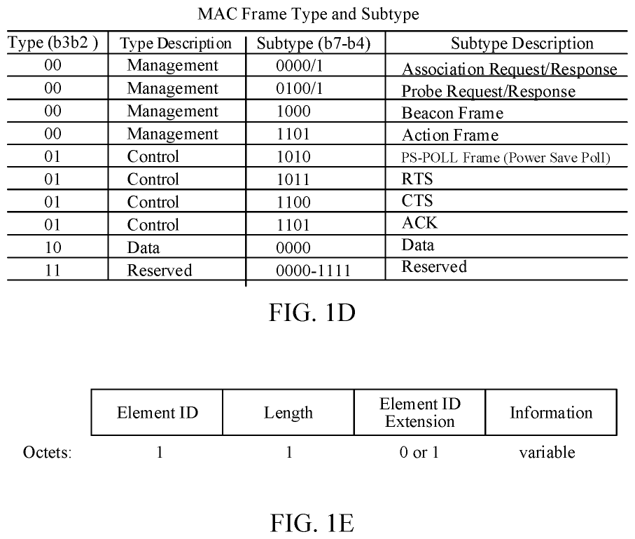

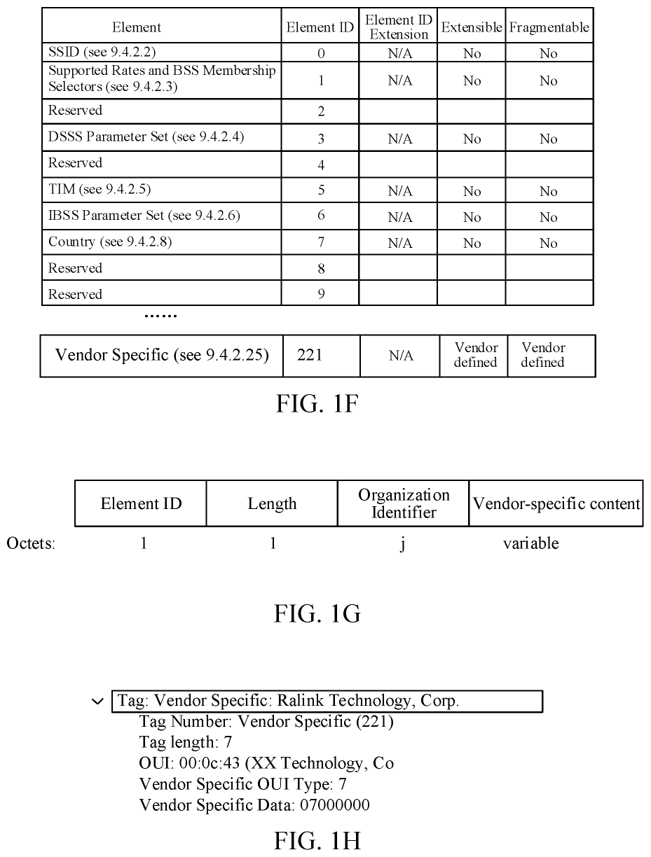

Embodiments of the present disclosure provide a device interaction method. As shown in FIG. 1A, the method includes the following.

At S110, a first network protocol probe frame sent by a third device is obtained in response to a first device being in an external device scanning stage, the first network protocol probe frame carrying second information of at least one second device.

The first device may be any type of terminal device having an external device scanning function. The external device scanning stage is device scanning automatically triggered by the first device in real time, and the frequency of the positioning-triggered scanning is very high. The third device may be a device capable of periodically broadcasting and sending the first network protocol probe frame, or sending a probe response frame to the first device in response to a probe request frame sent by the first device during the external device scanning stage. The first network protocol may be a protocol that enables the third device to broadcast and send a probe frame or send a probe response frame.

The first network protocol may be a wireless communication protocol, i.e., a protocol used for communication between devices in a wireless communication environment and responsible for networking and communication between devices in a network, for example, Wireless Fidelity (Wi-Fi), IPV6 Ethernet (6Ethernet), Radio Frequency Identification (RFID), Near Field Communication (NFC), Zigbee, IPV6 Low-Rate Wireless Personal Area Network (6LoWPAN), Global System for Mobile Communications (GSM), General Packet Radio Service (GPRS), Bluetooth (Bluetooth, BT), 3G, 4G, 5G, or the like. These protocols can ensure the security and reliability of data transmitted over a network.

For example, the first network protocol may be a Wi-Fi network protocol, the third device may be a Wi-Fi routing device, and the first device and the second device may be terminal devices capable of connecting to the Wi-Fi routing device. In the present disclosure, the Wi-Fi driver can be automatically loaded when the first device is powered on, and the Wi-Fi driver remains in an activated state and is not affected even if the Wi-Fi function is disabled. As one of the most fundamental capabilities of an electronic device, the Wi-Fi driver remaining in an activated state does not introduce additional overhead. Since Wi-Fi routers provide much greater coverage than BT or NFC, electronic devices connected to clustered routers can achieve rapid connections across floors, buildings, and throughout an entire campus.

In some embodiments, the first network protocol probe frame may be a Wi-Fi MAC probe frame. FIG. 1B schematically shows a MAC frame structure provided in embodiments of the present disclosure. As shown in FIG. 1B, the MAC header of the MAC frame includes Frame Control. FIG. 1C schematically shows a Frame Control structure provided in embodiments of the present disclosure. As shown in FIG. 1C, the Frame Control includes a Type byte and a Subtype byte. FIG. 1D is a table of a Type byte and a Subtype byte provided in embodiments of the present disclosure. As shown in FIG. 1D, the table includes a Beacon frame, a Probe Request frame, and a Probe Response frame.

In the present disclosure, the Beacon frame, Probe Request frame, and Probe Response frame are Wi-Fi MAC management frames, and can be sent and received regardless of whether a router is connected. The Beacon frame and Probe Request frame are broadcast frames, and the Probe Response frame is a unicast frame. Data in the frame body is filled through Elements. FIG. 1E schematically shows an Element structure provided in embodiments of the present disclosure, and FIG. 1F is an Element ID filling table provided in embodiments of the present disclosure. As shown in FIG. 1F, some Element IDs are reserved (Reserved), i.e., have not yet been used. During implementation, these IDs may be used, or the Vendor Specific 221 customizable field may be directly used to carry the second information. FIG. 1G schematically shows a Vendor Specific 221 frame structure provided in embodiments of the present disclosure. As shown in FIG. 1G, the Vendor Specific 221 includes an Element ID, a Length, an Organization Identifier, and Vendor-specific content. FIG. 1H schematically shows the filling content of a Vendor Specific 221 frame provided in embodiments of the present disclosure. As shown in FIG. 1H, the Number is Vendor Specific 221, the Length is 7, the Organization Identifier (OUI) is 00:0C:43 and represents a vendor identifier, and the Vendor-specific content includes a Type of 7 and Data of 07000000. During implementation, a user may fill the second information into the OUI, Type, and Data according to needs.

The three frame types, namely the Beacon frame, Probe Request frame, and Probe Response frame, each include one or more Element ID 221 Vendor Specific fields. At present, Wi-Fi scanning on most devices is implemented independently and is not limited by the Wi-Fi switch. In this way, the Vendor Specific field can be utilized without any additional operation to discover needed devices and perform information sharing before connection.

During implementation, the first device may automatically trigger device scanning in real time. Each time the first device triggers external device scanning, the first network protocol probe frame sent by the third device may be obtained to update surrounding connectable devices (second devices). In the present disclosure, discovery of the second devices and information sharing are almost real-time. The frequency of the positioning-triggered scanning is very high, such that surrounding connectable devices are updated during substantially every scan because of the automatic scanning of the first device.

At S120, the first network protocol probe frame is parsed, and second connection information included in the second information and used for establishing a connection with an external device is obtained.

In the present disclosure, the second connection information includes at least one of the following: a connected Service Set Identifier (SSID), a local area network address of a wireless access point, a device tag, a connected application identifier, a device name, or an attribute of the device.

The attribute of the device includes at least one of the following: a screen size, a resolution, audio encoding and decoding, video encoding and decoding, or a transmission rate.

In some embodiments, the second connection information further includes a Basic Service Set Identifier (BSSID). For example, a company may occupy a relatively large area and may have a plurality of wireless access points (APs) or wireless routers installed. Company employees need only a single SSID to access the wireless network anywhere within the company. The BSSID may be the MAC address of each wireless access point. When an employee moves within the company, the SSID remains unchanged. However, the BSSID continuously changes as device switches between different wireless access points.

In some embodiments, the second connection information further includes a TCP/UDP port. The TCP protocol is the Transmission Control Protocol (TCP), and the UDP protocol is the User Datagram Protocol (UDP), both of which are transport layer protocols.

During implementation, the first device may parse the first network protocol probe frame to obtain at least one of the above second connection information items. For example, the first device may obtain the connected Service Set Identifier of the second device, the local area network address of the wireless access point, and the device name.

At S130, it is determined that the first device requests to connect to the second device, and a connection with the second device is established based on the second connection information.

For example, based on the second connection information, when the first device requests to establish a Wi-Fi peer-to-peer (Wi-Fi P2P), BT, or NFC connection with the second device, the connection may be established based on the above second connection information.

In embodiments of the present disclosure, first, in response to the first device being in an external device scanning stage, a first network protocol probe frame sent by a third device is obtained, the first network protocol probe frame carrying second information of at least one second device. Then, the first network protocol probe frame is parsed to obtain second connection information included in the second information and used for establishing a connection with an external device. Finally, it is determined that the first device requests to connect to the second device, and a connection with the second device is established based on the second connection information. In this way, the first device can obtain the second information during the external device scanning stage, such that when requesting to connect to the second device, the first device can quickly and accurately connect to the second device without a prior negotiation process, thereby effectively improving the connection efficiency between devices. Whether for one-to-one connections or one-to-many connections, the solution is similarly highly efficient and has significant advantages in Internet of Things (IoT) and interconnected-everything scenarios.

In some embodiments, the above S110, “responding to a first device being in an external device scanning stage, obtaining a first network protocol probe frame sent by a third device,” may be implemented through one of the following.

At S111, in the external device scanning stage, in response to a probe request frame sent by the first device, a probe response frame from the third device is received by the first device as the first network protocol probe frame.

During implementation, in the external device scanning stage, the first device may send a probe request frame to the third device, and the third device, in response to obtaining the probe request frame, may send a probe response frame to the first device. The probe response frame may include device information of other devices obtained by the third device. For example, during a Wi-Fi scanning stage, a terminal serving as the first device may send a Probe Request frame to a routing device serving as the third device. After receiving the Probe Request frame, the routing device returns a Probe Response frame to the terminal, and the Probe Response frame may carry information of other connected terminals obtained through scanning by the routing device. In some embodiments, information of the other connected terminals may be stored in a preset information table in the routing device. The information table may be updated in real time based on changes in terminals connected to the routing device. In this way, the terminal device can obtain the latest information table in real time.

At S112, during the external device scanning stage, a beacon frame broadcast by the third device is listened for and received by the first device as the first network protocol probe frame.

During implementation, the third device may periodically send beacon frames through broadcasting, and the first device listens for the broadcast to obtain the first network protocol frame. For example, during a Wi-Fi scanning stage, a routing device serving as the third device broadcasts a Beacon frame, and a terminal serving as the first device may receive the Beacon frame. The Beacon frame may carry information of connected terminals obtained through scanning by the routing device, and the connected terminals may be the first device and the second device, i.e., the first device and the second device are both devices connected to the third device and may occupy equivalent positions in the network. In some embodiments, information of the connected terminals may be stored in a preset information table in the routing device. The information table may be updated in real time based on changes in terminals connected to the routing device. In this way, the terminal devices (the first device and the second device) can obtain the latest information table in real time.

In embodiments of the present disclosure, during the external device scanning stage, in response to a probe request frame sent by the first device, the first device receives a probe response frame from the third device as the first network protocol probe frame. In some embodiments, during the external device scanning stage, the first device listens for and receives a beacon frame broadcast by the third device as the first network protocol probe frame. In this way, the first device can obtain either a probe response frame or a beacon frame as the first network protocol probe frame.

In some embodiments, before “the first device receives the probe response frame from the third device as the first network protocol probe frame” in the above S111, the following is further included.

At S113, in response to the first device being in the external device scanning stage, a probe request frame is sent by the first device to the third device, where the probe request frame carries first information of the first device, and the first information includes first connection information used for establishing a connection with an external device.

During implementation, the first device is equivalent to the second device, i.e., the first device and/or the second device each send a probe request frame to the third device during the external device scanning stage. The probe request frame sent by the first device carries first information, and the probe request frame sent by the second device carries second information. The third device may obtain device information of any device that sends a probe request frame thereto. For example, a routing device serving as the third device may obtain terminal information of any terminal that sends a probe request frame thereto during the external device scanning stage, and the terminal information includes connection information for establishing a connection between the terminal and another terminal. The connection may be a BT connection or an NFC connection.

In embodiments of the present disclosure, in response to the first device being in the external device scanning stage, the first device sends a probe request frame to the third device. In this way, the third device can receive device information of devices that send probe request frames thereto.

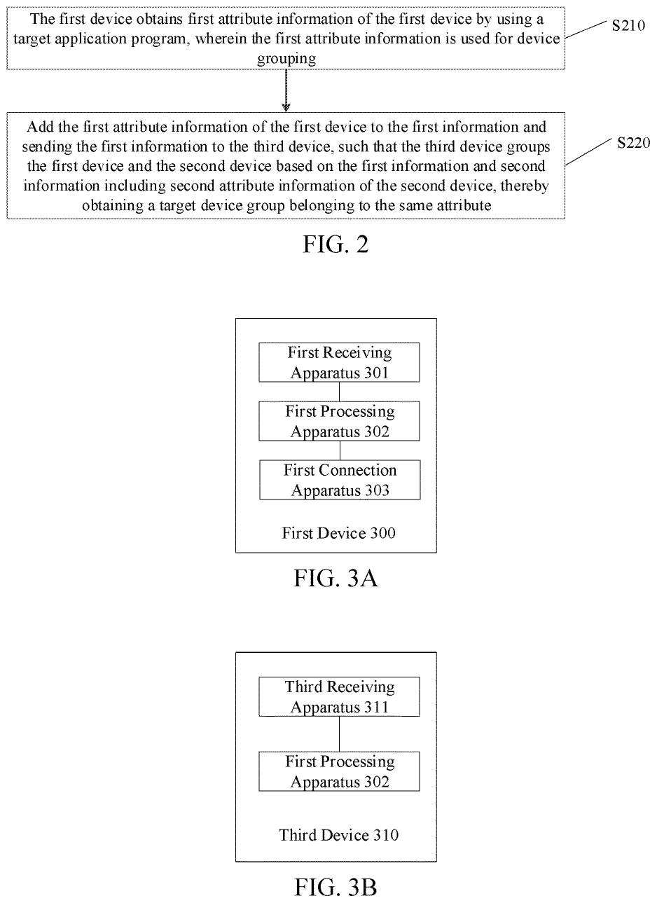

In some embodiments, as shown in FIG. 2, the above S113, “in response to the first device being in the external device scanning stage, the first device sends a probe request frame to the third device,” may be implemented through the following.

At S210, first attribute information of the first device is obtained by the first device using a target application program, the first attribute information being used for device grouping;

In the present disclosure, the target application program may be an application program installed in the first device or the second device. The target application program may be used to obtain first attribute information of the first device or second attribute information of the second device.

The first attribute information includes at least one of the following types of information: connection capability, location information, or a user-configured identifier. During implementation, the first attribute information may be used for device grouping. For example, based on the connection capability, devices may be divided into a group having Bluetooth connection capability and a group having NFC connection capability. Based on location information, devices within the same location range may be divided into the same group, where the location range may be the same room, the same building, or the same work campus. Based on a user-configured identifier, devices having the same identifier may be divided into the same group. A user may configure the same identifier for devices managed by the user, such that devices managed by the user are divided into the same group.

At S220, the first attribute information of the first device is added to the first information, and the first information is sent to the third device, such that the third device groups the first device and the second device based on the first information and second information including second attribute information of the second device, thereby obtaining a target device group having the same attribute.

During implementation, the target application program may be used to add the first attribute information to the first information and send the first information to the third device. In this way, the third device can group the first device and the second device based on the first attribute information and the second attribute information.

In some embodiments, when the third device broadcasts a Beacon frame or returns a Probe Response frame to the first device or the second device, the third device sends or returns only information of devices having the target application program identifier. In this way, an electronic device configured with the target application program can efficiently obtain information of other electronic devices configured with the same target application program, thereby improving connection efficiency.

In embodiments of the present disclosure, the first device uses a target application program to obtain first attribute information of the first device, the first attribute information being used for device grouping. The first attribute information of the first device is added to the first information, such that the third device groups the first device and the second device based on the first information and second information including second attribute information of the second device, thereby obtaining a target device group having the same attribute. In this way, first attribute information used for device grouping can be obtained by configuring the target application program on the first device, and the third device can group the first device and the second device. Sending information after grouping can effectively improve connection efficiency.

In some embodiments, the above S110, “responding to a first device being in an external device scanning stage, obtaining a first network protocol probe frame sent by a third device,” may be implemented through the following process.

In response to the first device being in the external device scanning stage, second connection information of at least one second device belonging to the target device group that includes the first device and sent by the third device is obtained.

During implementation, since the third device can group the second device and the first device based on the second attribute information and the first attribute information, when the third device sends the first network protocol probe frame to the first device, the third device may send second connection information of at least one second device belonging to the target device group that includes the first device. For example, based on connection capability, the third device may divide devices into a group having BT connection capability and a group having NFC connection capability, and then send second connection information of a second device having the same BT connection capability as the first device to the first device. The third device may group devices within the same location range into the same group based on location information, where the location range may be the same room, the same building, or the same work campus, and then send second connection information of a second device belonging to the same room as the first device to the first device. The third device may group devices having the same identifier into the same group based on a user-configured identifier. A user may configure the same identifier for devices managed by the user, such that devices managed by the user are divided into the same group. The third device may then send second connection information of a second device having the same identifier as the first device to the first device.

In embodiments of the present disclosure, in response to the first device being in the external device scanning stage, the first device obtains second connection information of at least one second device belonging to the target device group that includes the first device and sent by the third device. In this way, by sending information of devices belonging to the same group to the first device, the first device can efficiently connect to devices that need to be connected.

Embodiments of the present disclosure provide a first device capable of connecting to a third device. As shown in FIG. 3A, the first device includes:

A first receiving apparatus 301, configured to, in response to the first device being in an external device scanning stage, obtain a first network protocol probe frame sent by the third device, the first network protocol probe frame carrying second information of at least one second device;

A first processing apparatus 302, configured to parse the first network protocol probe frame and obtain second connection information included in the second information and used for establishing a connection with an external device;

A first connection apparatus 303, configured to determine that the first device requests to connect to the second device and establish a connection with the second device based on the second connection information.

In embodiments of the present disclosure, first, the first receiving apparatus, in response to the first device being in an external device scanning stage, obtains a first network protocol probe frame sent by the third device, the first network protocol probe frame carrying second information of at least one second device. Then, the first processing apparatus parses the first network protocol probe frame to obtain second connection information included in the second information and used for establishing a connection with an external device. Finally, the first connection apparatus determines that the first device requests to connect to the second device and establishes a connection with the second device based on the second connection information. In this way, the first device can obtain the second information during the external device scanning stage, such that when requesting to connect to the second device, the first device can quickly and accurately connect to the second device without a prior negotiation process, thereby effectively improving the connection efficiency between devices. Whether for one-to-one connections or one-to-many connections, the solution is similarly highly efficient and has significant advantages in Internet of Things scenarios involving interconnected devices.

Embodiments of the present disclosure provide a third device capable of connecting to a first device and a second device. As shown in FIG. 3B, the third device includes:

A third receiving apparatus 311, configured to obtain a probe request frame sent by the second device during an external device scanning stage, where the probe request frame carries second information of the second device, and the second information includes second connection information used for establishing a connection with an external device;

A third sending apparatus 312, configured to add the second connection information to a beacon frame for broadcasting, such that the first device obtains the second connection information; or, the third sending apparatus 312, configured to, in response to a probe request frame sent by the first device, add the second connection information to a probe response frame and send the probe response frame to the first device.

For example, the third device may be a routing device, and the first device and the second device may be devices capable of connecting to the routing device. Based on received Probe Request information, the routing device may maintain a device interconnection table that stores information of surrounding devices, such as manufacturer, IP address, port, device name, device capability, or the like. The information may be broadcast to surrounding devices through Beacon frames, or information of devices that need connection may be returned to a specific device through a Probe Response frame, thereby synchronizing information of surrounding interconnected devices in real time and with high efficiency.

In embodiments of the present disclosure, the third receiving apparatus obtains a probe request frame sent by the second device during an external device scanning stage, where the probe request frame carries second information of the second device, and the second information includes second connection information used for establishing a connection with an external device. The third sending apparatus adds the second connection information to a beacon frame for broadcasting, such that the first device obtains the second connection information. In some embodiments, in response to a probe request frame sent by the first device, the third sending apparatus adds the second connection information to a probe response frame and sends the probe response frame to the first device. In this way, the first device can obtain the second information during the external device scanning stage, such that when requesting to connect to the second device, the first device can quickly and accurately connect to the second device without a prior negotiation process, thereby effectively improving the connection efficiency between devices. Whether for one-to-one connections or one-to-many connections, the solution is similarly highly efficient and has significant advantages in Internet of Things scenarios involving interconnected devices.

In some embodiments, the third receiving apparatus of the third device is further configured to receive a probe request frame sent by the first device during an external device scanning stage, where the probe request frame carries first information of the first device, the first information includes first connection information and first attribute information, the second information includes second connection information and second attribute information, and the first attribute information and the second attribute information are used for device grouping.

The third device further includes a third processing apparatus configured to group all the first devices and the second devices based on the first attribute information and the second attribute information, thereby obtaining a target device group having the same attribute.

Correspondingly, the third sending apparatus is configured to add second connection information of a device belonging to the same group as the first device to a beacon frame for broadcasting, or add the second connection information to a probe response frame and send the probe response frame to the first device.

In embodiments of the present disclosure, the third device can group all the first devices and the second devices based on the first attribute information and the second attribute information, and after grouping, add second connection information of a device belonging to the same group as the first device to a beacon frame for broadcasting or add the second connection information to a probe response frame and send the probe response frame to the first device. In this way, by sending information of devices belonging to the same group to the first device, the first device can efficiently connect to devices that need to be connected.

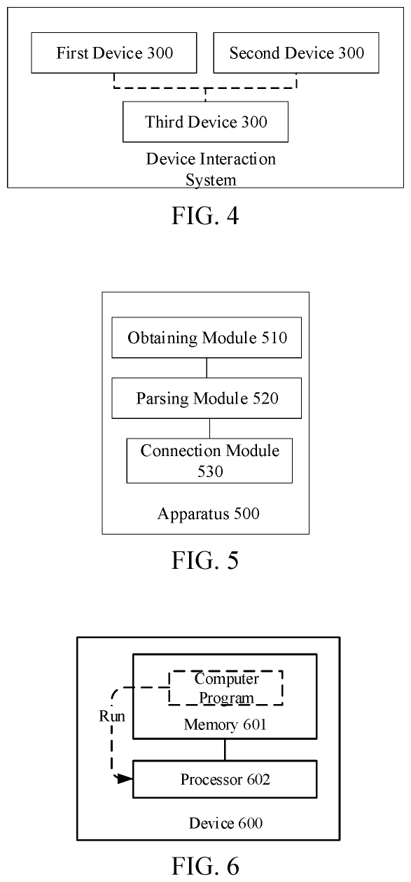

Embodiments of the present disclosure provide a device interaction system. As shown in FIG. 4, the system includes a first apparatus 300, a second apparatus 320, and a third apparatus 310, where the first apparatus 300 and the second apparatus 320 are respectively connected to the third apparatus 310.

For example, when a first device and a second device are connected to a routing device (third device) having the same SSID, the following information may be filled into the Vendor Specific field of the three frame types: SSID, BSSID, IP address, TCP/UDP port, a same-manufacturer device tag (tag), connection application ID, device name, device capabilities (screen size, resolution, supported audio/video codecs, supported transmission rates), or the like. After this information is obtained, device basic capabilities can be utilized to discover desired and connectable devices almost in real time without additional dependencies, thereby shortening the time needed to discover devices.

In embodiments of the present disclosure, the first device and the second device are respectively connected to the third device. The first device can obtain the second information during the external device scanning stage, such that when requesting to connect to the second device, the first device can quickly and accurately connect to the second device without a prior negotiation process, thereby effectively improving the connection efficiency between devices. Whether for one-to-one connections or one-to-many connections, the solution is similarly highly efficient and has significant advantages in Internet of Things scenarios involving interconnected devices.

In some embodiments, for devices that are not connected or are connected to different SSIDs, the following information may be filled into the Vendor Specific field of the three frame types: a peer-to-peer physical (P2P MAC) address, a P2P scanning frequency band, a same-manufacturer device tag, a connection application ID, a device name, device capabilities (screen size, resolution, supported audio/video codecs, supported transmission rates), or the like, as well as any link-layer information needed for peer-to-peer connection interaction. After this information is obtained, device basic capabilities can be utilized to connect desired and connectable devices in the most appropriate manner quickly and accurately without a prior negotiation process.

Based on the foregoing embodiments, embodiments of the present disclosure provide a device interaction apparatus. The apparatus includes the modules described above, each module includes corresponding submodules, and each submodule includes units, which may be implemented by a processor in an electronic device. Of course, the apparatus may also be implemented by specific logic circuits. During implementation, the processor may be a Central Processing Unit (CPU), a Microprocessor Unit (MPU), a Digital Signal Processor (DSP), a Field Programmable Gate Array (FPGA), or the like.

FIG. 5 is a schematic structural diagram of a device interaction apparatus provided in embodiments of the present disclosure. As shown in FIG. 5, the apparatus 500 includes the following.

An obtaining module 510, configured to, in response to a first device being in an external device scanning stage, obtain a first network protocol probe frame sent by a third device, the first network protocol probe frame carrying second information of at least one second device;

A parsing module 520, configured to parse the first network protocol probe frame and obtain second connection information included in the second information and used for establishing a connection with an external device;

A connection module 530, configured to determine that the first device requests to connect to the second device and establish a connection with the second device based on the second connection information.

In some embodiments, the obtaining module 510 includes a receiving submodule or a listening submodule. The receiving submodule is configured to, during the external device scanning stage, in response to a probe request frame sent by the first device, enable the first device to receive a probe response frame from the third device as the first network protocol probe frame. The listening submodule is configured to enable the first device to listen for and receive a beacon frame broadcast by the third device during the external device scanning stage as the first network protocol probe frame.

In some embodiments, the obtaining module 510 further includes a sending submodule, configured to, while the first device is in the external device scanning stage, send a probe request frame from the first device to the third device, where the probe request frame carries first information of the first device, and the first information includes first connection information used for establishing a connection with an external device.

In some embodiments, the sending submodule includes an obtaining unit and an adding-and-sending unit. The obtaining unit is configured to enable the first device to obtain first attribute information of the first device by using a target application program, the first attribute information being used for device grouping. The adding-and-sending unit is configured to add the first attribute information of the first device to the first information and send the first information to the third device, such that the third device groups the first device and the second device based on the first information and second information including second attribute information of the second device, thereby obtaining a target device group having the same attribute.

In some embodiments, the obtaining module 510 is further configured to, in response to the first device being in the external device scanning stage, obtain second connection information of at least one second device belonging to the target device group that includes the first device and sent by the third device.

In some embodiments, the second connection information includes at least one of the following: a connected Service Set Identifier, a local area network address of a wireless access point, a device tag, a connected application identifier, a device name, or an attribute of the device.

The descriptions of the above apparatus embodiments are similar to the descriptions of the above method embodiments and have beneficial effects similar to those of the method embodiments. For technical details not disclosed in the apparatus embodiments of the present disclosure, reference may be made to the descriptions of the method embodiments of the present disclosure for understanding.

It should be noted that, in embodiments of the present disclosure, if the above method is implemented in the form of software functional modules and sold or used as an independent product, the method may also be stored in a computer-readable storage medium. Based on such an understanding, the technical solutions of embodiments of the present disclosure, or the part thereof that contributes to the related art, may be embodied in the form of a software product. The computer software product is stored in a storage medium and includes a plurality of instructions for causing an electronic device (which may be a mobile phone, tablet computer, notebook computer, desktop computer, or the like) to execute all or part of the methods described in the various embodiments of the present disclosure. The foregoing storage medium includes various media capable of storing program code, such as a USB flash drive, a removable hard disk, a Read Only Memory (ROM), a magnetic disk, or an optical disc. Embodiments of the present disclosure are not limited to any specific combination of hardware and software.

Correspondingly, embodiments of the present disclosure provide a storage medium storing a computer program that, when executed by a processor, implements the device interaction method provided in the above embodiments.

Correspondingly, embodiments of the present disclosure provide an electronic device. FIG. 6 is a schematic diagram of a hardware entity of an electronic device provided in embodiments of the present disclosure. As shown in FIG. 6, the hardware entity of the device 600 includes a memory 601 and a processor 602. The memory 601 stores a computer program executable on the processor 602, and the processor 602, when executing the program, implements the device interaction method provided in the above embodiments.

The memory 601 is configured to store instructions and applications executable by the processor 602, and may further cache data to be processed or already processed by the processor 602 and various modules in the electronic device 600 (for example, image data, audio data, voice communication data, and video communication data). The memory 601 may be implemented by a flash memory (FLASH) or a Random Access Memory (RAM).

It should be noted that the descriptions of the above storage medium and device embodiments are similar to the descriptions of the above method embodiments and have beneficial effects similar to those of the method embodiments. For technical details not disclosed in the storage medium and device embodiments of the present disclosure, reference may be made to the descriptions of the method embodiments of the present disclosure for understanding.

It should be understood that reference throughout the specification to “one embodiment” or “an embodiment” means that a particular feature, structure, or characteristic related to the embodiment is included in at least one embodiment of the present disclosure. Therefore, occurrences of “in one embodiment” or “in an embodiment” throughout the specification do not necessarily refer to the same embodiment. In addition, these particular features, structures, or characteristics may be combined in any suitable manner in one or more embodiments. It should be understood that, in the various embodiments of the present disclosure, the numerical order of the above processes does not indicate the order of execution. The execution order of the processes should be determined according to their functions and internal logic and should not constitute any limitation on the implementation process of embodiments of the present disclosure. The serial numbers of the above embodiments of the present disclosure are used only for description and do not represent the relative merits of the embodiments.

It should be noted that, as used herein, the terms “include”, “contain”, or any other variations thereof are intended to cover a non-exclusive inclusion, such that a process, method, article, or apparatus that includes a series of elements includes not only those elements but also other elements not expressly listed, or elements inherent to such process, method, article, or apparatus. In the absence of further limitations, an element defined by the phrase “including one . . . ” does not preclude the presence of additional identical elements in the process, method, article, or apparatus that includes the element.

In the several embodiments provided in the present disclosure, it should be understood that the disclosed devices and methods may be implemented in other manners. The device embodiments described above are merely illustrative. For example, the division of the units is merely a logical functional division, and other division manners may be adopted in actual implementation. For example, multiple units or components may be combined, may be integrated into another system, or some features may be omitted or not executed. In addition, the coupling, direct coupling, or communication connection between the various components shown or discussed may be implemented through interfaces, and indirect coupling or communication connection between devices or units may be electrical, mechanical, or in other forms.

The units described above as separate components may or may not be physically separated, and the components displayed as units may or may not be physical units. The units may be located in one place or distributed across multiple network units. Some or all of the units may be selected according to actual needs to achieve the objectives of the solutions of the embodiments.

In addition, the functional units in the various embodiments of the present disclosure may all be integrated into one processing unit, may each be implemented as a separate unit, or two or more units may be integrated into one unit. The above integrated unit may be implemented in the form of hardware, or in the form of hardware combined with software functional units.

A person of ordinary skill in the art can understand that all or part of the above method embodiments may be implemented by hardware associated with program instructions. The foregoing program may be stored in a computer-readable storage medium, and when executed, the program executes the processes included in the above method embodiments. The foregoing storage medium includes various media capable of storing program code, such as a removable storage device, a Read Only Memory (ROM), a magnetic disk, or an optical disc.

In some embodiments, if the above integrated units of the present disclosure are implemented in the form of software functional modules and sold or used as an independent product, the integrated units may also be stored in a computer-readable storage medium. Based on such an understanding, the technical solutions of embodiments of the present disclosure, or the part thereof that contributes to the related art, may be embodied in the form of a software product. The computer software product is stored in a storage medium and includes a plurality of instructions for causing an electronic device (which may be a mobile phone, tablet computer, notebook computer, desktop computer, or the like) to execute all or part of the methods described in the various embodiments of the present disclosure. The foregoing storage medium includes various media capable of storing program code, such as a removable storage device, a ROM, a magnetic disk, or an optical disc.

The methods disclosed in the several method embodiments provided in the present disclosure may be combined in any manner where no conflict exists, thereby obtaining new method embodiments.

The features disclosed in the several product embodiments provided in the present disclosure may be combined in any manner where no conflict exists, thereby obtaining new product embodiments.

The features disclosed in the several method embodiments or device embodiments provided in the present disclosure may be combined in any manner where no conflict exists, thereby obtaining new method embodiments or device embodiments.

The foregoing descriptions are merely embodiments of the present disclosure, but the scope of the present disclosure is not limited thereto. Any changes or substitutions that can be readily conceived by a person skilled in the art within the technical scope disclosed by the present disclosure shall fall within the scope of the present disclosure. Therefore, the scope of the present disclosure shall be determined by the scope of the claims.

What is claimed is:

1. A device interaction method comprising:
obtaining, in response to a first device being in an external device scanning stage, a first network protocol probe frame sent by a third device, the first network protocol probe frame carrying second information of at least one second device;
parsing the first network protocol probe frame, and obtaining second connection information included in the second information and used for establishing a connection with an external device; and
determining that the first device requests to connect to a second device of the at least one second device, and establishing a connection with the second device based on the second connection information.

2. The method according to claim 1, wherein obtaining, in response to the first device being in the external device scanning stage, the first network protocol probe frame sent by the third device includes:
responding to a probe request frame sent by the first device during the external device scanning stage, and receiving, by the first device, a probe response frame from the third device as the first network protocol probe frame.

3. The method according to claim 1, wherein obtaining, in response to the first device being in the external device scanning stage, the first network protocol probe frame sent by the third device includes:
during the external device scanning stage, listening for and receiving, by the first device, a beacon frame broadcast by the third device as the first network protocol probe frame.

4. The method according to claim 2, further comprising:
in response to the first device being in the external device scanning stage, sending the probe request frame to the third device by the first device, the probe request frame carrying first information of the first device, and the first information including first connection information used for establishing a connection with the external device.

5. The method according to claim 4, wherein, in response to the first device being in the external device scanning stage, sending the probe request frame to the third device by the first device includes:
obtaining, by the first device using a target application program, first attribute information of the first device, the first attribute information being used for device grouping;
adding the first attribute information of the first device to the first information and sending the first information to the third device, such that the third device groups the first device and the second device based on the first information and second information including second attribute information of the second device, thereby obtaining a target device group having the same attribute.

6. The method according to claim 5, wherein obtaining, in response to the first device being in the external device scanning stage, the first network protocol probe frame sent by the third device includes:
obtaining, in response to the first device being in the external device scanning stage, the second connection information of the at least one second device belonging to a target device group that includes the first device and sent by the third device.

7. The method according to claim 1, wherein the second connection information includes at least one of: a connected Service Set Identifier, a local area network address of a wireless access point, a device tag, a connected application identifier, a device name, or an attribute of a device.

8. An electronic device comprising:
a processor, and
a memory storing an application program that, when executed by the processor, causes the electronic device to:
obtain, in response to a first device being in an external device scanning stage, a first network protocol probe frame sent by a third device, the first network protocol probe frame carrying second information of at least one second device;
parse the first network protocol probe frame, and obtain second connection information included in the second information and used for establishing a connection with an external device; and
determine that the first device requests to connect to a second device of the at least one second device, and establish a connection with the second device based on the second connection information.

9. The electronic device according to claim 8, wherein the application program, when executed by the processor, further causes the electronic device to, when obtaining, in response to the first device being in the external device scanning stage, the first network protocol probe frame sent by the third device:
respond to a probe request frame sent by the first device during the external device scanning stage, and receive, by the first device, a probe response frame from the third device as the first network protocol probe frame.

10. The electronic device according to claim 8, wherein the application program, when executed by the processor, further causes the electronic device to, when obtaining, in response to the first device being in the external device scanning stage, the first network protocol probe frame sent by the third device:
during the external device scanning stage, listen for and receive, by the first device, a beacon frame broadcast by the third device as the first network protocol probe frame.

11. The electronic device according to claim 9, wherein the application program, when executed by the processor, further causes the electronic device to:
in response to the first device being in the external device scanning stage, send the probe request frame to the third device by the first device, the probe request frame carrying first information of the first device, and the first information including first connection information used for establishing a connection with the external device.

12. The electronic device according to claim 11, wherein the application program, when executed by the processor, further causes the electronic device to, when sending the probe request frame to the third device by the first device in response to the first device being in the external device scanning stage:
obtain, by the first device using a target application program, first attribute information of the first device, the first attribute information being used for device grouping;
add the first attribute information of the first device to the first information and send the first information to the third device, such that the third device groups the first device and the second device based on the first information and second information including second attribute information of the second device, thereby obtaining a target device group having the same attribute.

13. The electronic device according to claim 12, wherein the application program, when executed by the processor, further causes the electronic device to, when obtaining, in response to the first device being in the external device scanning stage, the first network protocol probe frame sent by the third device:
obtain, in response to the first device being in the external device scanning stage, the second connection information of the at least one second device belonging to a target device group that includes the first device and sent by the third device.

14. The electronic device according to claim 8, wherein the second connection information includes at least one of: a connected Service Set Identifier, a local area network address of a wireless access point, a device tag, a connected application identifier, a device name, or an attribute of a device.

15. A non-transitory computer-readable storage medium storing an application program that, when executed by a processor, causes an electronic device including the processor to:
obtain, in response to a first device being in an external device scanning stage, a first network protocol probe frame sent by a third device, the first network protocol probe frame carrying second information of at least one second device;
parse the first network protocol probe frame, and obtain second connection information included in the second information and used for establishing a connection with an external device; and
determine that the first device requests to connect to a second device of the at least one second device, and establish a connection with the second device based on the second connection information.

16. The storage medium according to claim 15, wherein the application program, when executed by the processor, further causes the electronic device including the processor to, when obtaining, in response to the first device being in the external device scanning stage, the first network protocol probe frame sent by the third device:
respond to a probe request frame sent by the first device during the external device scanning stage, and receive, by the first device, a probe response frame from the third device as the first network protocol probe frame.

17. The storage medium according to claim 15, wherein the application program, when executed by the processor, further causes the electronic device including the processor to, when obtaining, in response to the first device being in the external device scanning stage, the first network protocol probe frame sent by the third device:
during the external device scanning stage, listen for and receive, by the first device, a beacon frame broadcast by the third device as the first network protocol probe frame.

18. The storage medium according to claim 16, wherein the application program, when executed by the processor, further causes the electronic device including the processor to:
in response to the first device being in the external device scanning stage, send the probe request frame to the third device by the first device, the probe request frame carrying first information of the first device, and the first information including first connection information used for establishing a connection with the external device.

19. The storage medium according to claim 18, wherein the application program, when executed by the processor, further causes the electronic device including the processor to, when sending the probe request frame to the third device by the first device in response to the first device being in the external device scanning stage:
obtain, by the first device using a target application program, first attribute information of the first device, the first attribute information being used for device grouping;
add the first attribute information of the first device to the first information and send the first information to the third device, such that the third device groups the first device and the second device based on the first information and second information including second attribute information of the second device, thereby obtaining a target device group having the same attribute.

20. The storage medium according to claim 19, wherein the application program, when executed by the processor, further causes the electronic device including the processor to, when obtaining, in response to the first device being in the external device scanning stage, the first network protocol probe frame sent by the third device:
obtain, in response to the first device being in the external device scanning stage, the second connection information of the at least one second device belonging to a target device group that includes the first device and sent by the third device.
